(19) United States
(12) Patent Application Publication
(10) Pub. No.: US 2014/0295204 A1
(43) Pub. Date: Oct. 2, 2014

(54) COMPOSITE STRUCTURE, FOR INSTANCE A COIN

(71) Applicant: Monnaie Royale Canadienne / Royal Canadian Mint, Ottawa (CA)

(72) Inventor: Xianyao Li, Ottawa (CA)

(21) Appl. No.: 14/355,025

(22) PCT Filed: Oct. 31, 2012
(86) PCT No.: PCT/CA2012/050773

§ 371 Date: Apr. 29, 2014

Related U.S. Application Data
(60) Provisional application No. 61/554,170, filed on Nov. 1, 2011.

(51) Int. Cl. A44C 21/00; B32B 3/08; B30B 15/30; B32B 15/01; B32B 37/10; B32B 7/08; B32B 3/26

(52) U.S. Cl. CPC A44C 21/00; B32B 7/08; B32B 3/08; B32B 3/26; B32B 15/01; B32B 37/10; B30B 15/30
USPC 428/596; 428/139; 428/66.6; 428/134; 72/377

(57) ABSTRACT

Generally, the present disclosure relates to a composite structure having at least three different components, and a process for manufacturing the same. The structure may be, but need not be, a metal coin. In one embodiment, the structure comprises an outer ring and two inserts stacked on top of each other and disposed within the outer ring. The outer ring and each of the two inserts are made of different materials. The outer ring and each of the inserts are locked together by a plurality of recesses formed in outer circumferential surfaces of the inserts. The structure may further comprise at least one interlayer disposed between the two inserts for adhering the two inserts to one another. The three major components and the interlayer may be made into a single structure by a striking force during coining or striking.

### FIELD

The present disclosure relates generally to composite structures, for instance metal coins or the like.

### BACKGROUND

Bi-metallic coins are commonly used as circulation coins in many countries. Many of such bi-metallic coins are made up of two differently colored metals, for instance an outer ring of a white nickel finish and an inner core of golden yellow bronze finish, or vice versa. Because a bi-color, bi-metallic coin is more complex to produce as compared to a mono-color, mono-metal coin, bi-metallic coins are usually used as higher denominations.

In order to manufacture bi-metallic coins, a locking mechanism may be used to lock the two pieces together. The following are examples of locking mechanisms:

1) A series of grooves parallel to the surface of the coin components are formed in the outer ring and ridges formed on the inner core. The two components are joined by force using a coining press (see for example U.S. Pat. No. 5,094,922 by Ielpo et al.).

2) A groove or a series of discontinuous grooves are formed in the periphery of the inner core, so that material from the outer ring will flow to partially fill the grooves upon joining by force during striking of the coins (see for example U.S. Pat. No. 4,472,891 by Ielpo and U.S. Pat. No. 5,630,288 by Lasset et al.).

3) Ridges are formed in the periphery of the inner core so that the excess material on the ridges is forced to flow into the inner circumferential surface of the outer ring in order to join the two components together. (see for example U.S. Pat. No. 6,189,197 by Kim).

4) The outer ring and inner core are of different thickness and hardness so that a lip or tongue is formed to cover the thinner pieces, for instance the inner core (see for example U.S. Pat. No. 6,044,541 by Truong). No grooves or ridges are used.

Bulgarian Patent Document No. BG 109647 by Bogdanov describes a three-colored, three metal coin. It appears that these coins are intended to be collector coins as opposed to circulation coins. While collector coins are usually well protected, circulation coins must be able to withstand much greater use. BG 109647 does not appear to describe a locking mechanism sufficient for use in circulation coins.

### SUMMARY

Generally, the present disclosure relates to a composite structure having at least three different components, and a process for manufacturing the same. The structure may be, but need not be, a metal coin. In one embodiment, the structure comprises an outer ring and two inserts stacked on top of each other and disposed within the outer ring. The outer ring and each of the two inserts are made of different materials. The outer ring and each of the inserts are locked together by a plurality of recesses formed in outer circumferential surfaces of the inserts. The structure may further comprise at least one interlayer disposed between the two inserts for adhering the two inserts to one another. The three major components and the interlayer may be made into a single structure by a striking force during coining or striking. In one embodiment, the outer ring, the one inner core, and the other inner core are made of different metals and are different colors. The coin may have increased security features and may be produced in an automated manner.

In a first aspect, the present disclosure provides a composite structure comprising: an outer ring; and two inserts stacked on top of each other and disposed within the outer ring; wherein: the outer ring and each of the two inserts are made of different materials; the outer ring and each of the inserts are locked together by a plurality of recesses formed in outer circumferential surfaces of the inserts.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic cross-sectional view of a coin, together with two inserts in perspective view, according to a disclosed embodiment.

FIG. 2 is a schematic cross-sectional view of a coin, according to a disclosed embodiment.

FIG. 3a is a schematic of an insert having chevron shaped recesses, according to a disclosed embodiment.

FIG. 3b is a schematic of an insert having angle recesses, according to a disclosed embodiment.

FIG. 4 is a schematic showing the feeding and placing of the three main components, according to a disclosed embodiment.

FIG. 5 is a schematic illustrating how the structure provides a particular EMS (electromagnetic signature), according to a disclosed embodiment.

FIG. 6 is a schematic illustrating how the structure provides a particular EMS (electromagnetic signature), according to a disclosed embodiment.

### DETAILED DESCRIPTION

The term “metal” as used herein includes metal alloys as well as plated metals and plated metal alloys.

While much of the discussion herein relates to coins and particularly metal coins, this is not intended to be limiting. Non-metal materials are expressly included, including, but not limited to, polymers, ceramics, and composites. Structures other than coins are also expressly included, for instance medals, medallions, and the like.

Generally, the present disclosure relates to a composite structure having at least three different components, and a process for manufacturing the same. The structure may be, but need not be, a metal coin. In one embodiment, the structure comprises an outer ring and two inserts stacked on top of each other and disposed within the outer ring. The outer ring and each of the two inserts are made of different materials. The outer ring and each of the inserts are locked together by a plurality of recesses formed in outer circumferential surfaces of the inserts. The structure may further comprise at least one interlayer disposed between the two inserts for adhering the two inserts to one another. The three major components and the interlayer may be made into a single structure by a striking force during coining or striking. In one embodiment, the outer ring, the one inner core, and the other inner core are made of different metals and are different colors. The coin may have increased security features and may be produced in an automated manner.

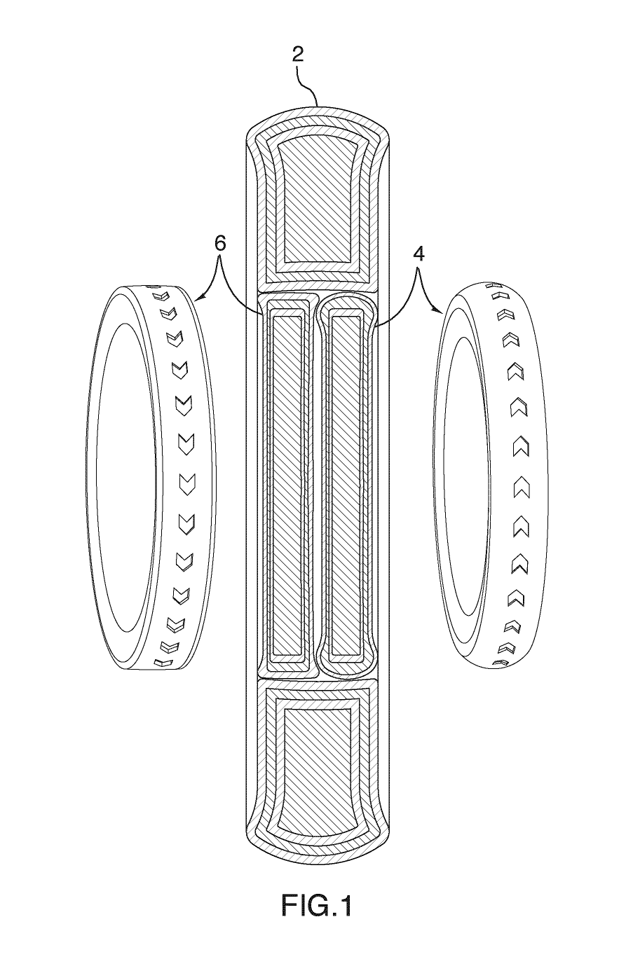

FIG. 1 illustrates one embodiment where the three major components are an outer ring (2) and two different inserts (4,6) of different compositions and colors which are sequentially placed into the middle of the outer ring (2). The three major components may be different metals. The two inserts (4,6) may be engineered in such a way that multi-ply platings are coated on metallic substrates and therefore unique interlayers of multiple metallic elements are formed in between the two inserts (4,6). The three major components may have different plated finishes, for instance the outer ring (2) being nickel, copper, nickel plated steel, and the first insert (4) being brass or bronze, copper, and nickel plated steel, and the second insert (6) being copper, nickel plated steel. As a result of coining from a so structured blank, the coin would have three colors or finishes, i.e., a white ring, a red upper insert, and a yellow lower insert.

The three major components may be interchangeable in terms of material compositions from the above-mentioned examples. That is, a so structured coin may, for instance, have a yellow ring, a red upper insert, and white lower insert. This is merely one example of a multitude of combinations that a designer may choose.

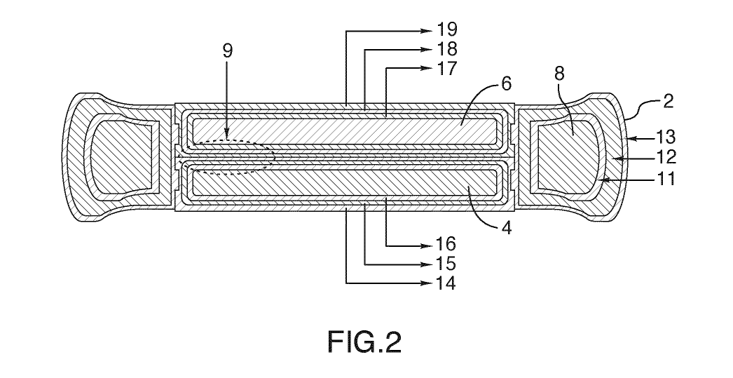

With reference to FIG. 2, the three major components may be designed and engineered as multi-ply plating structures, for instance the outer ring (2) being a steel core (8) with three layers of plating, such as Layer 1 (11), Layer 2 (12) and Layer 3 (13), and the two inserts (4,6) being two different metallic substrates, electroplated of different multiple-ply platings, such as Layer 4 (14) Layer 5 (15), Layer 6 (16), Layer 7 (17), Layer 8 (18) and Layer 9 (19), as schematically shown in FIG. 2. The sum of six layers in the interface (9) between the two plated inserts may have total thickness of up to 60 μm, or 20 to 60 μm), which is thick enough to contribute a unique security feature, i.e. a unique combination of electro magnetic signals (EMS) of the coin.

According to an embodiment, the following process may be used to produce such a coin:

1. Producing an outer ring of a material, either a metal or a metal alloy, or a plated material.
a) If a metal or a metal alloy is used, the main steps may be:
   i. Preparing a cut blank;
   ii. Preparing the blank edge by a rimming process with a rimming segment of pre-determined rimming profile;
   iii. Preparing an inner hole or opening by a piercing process;
   iv. Annealing to achieve an appropriate hardness.
b) If a plated material is used, the main steps may be:
   i. Preparing a cut blank;
   ii. Preparing the blank edge by a rimming process with a rimming segment of pre-determined rimming profile;
   iii. Preparing an inner hole or opening by a piercing process;
   iv. Deburing and cleaning;
   v. Effecting a plating process including annealing, cleaning, and barrel plating, as well as post annealing when needed.

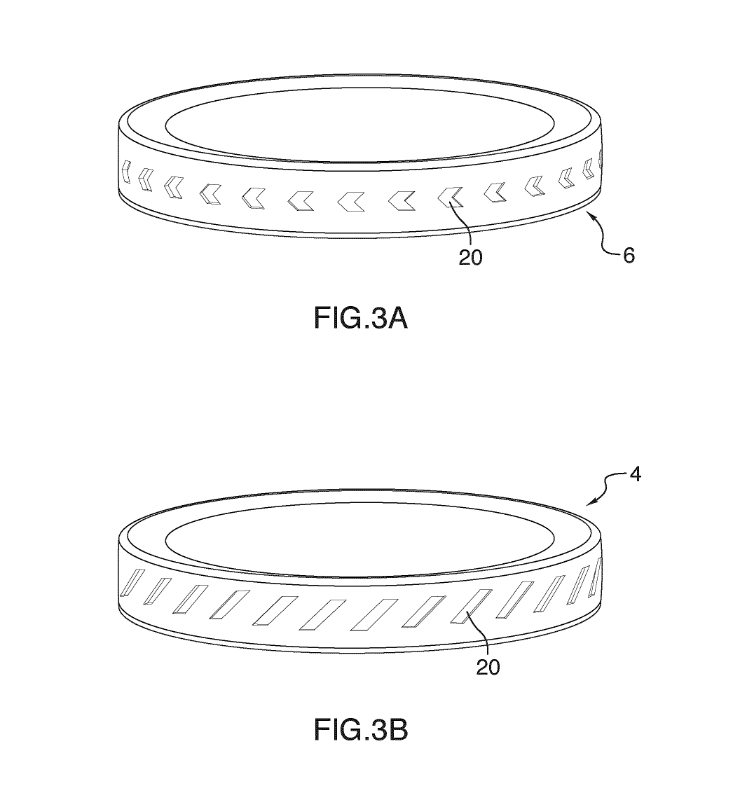

2. Producing the first inner insert of a different material as compared to the outer ring, either different metal or metal alloy, or a plated material.
a) If a metal or a metal alloy is used, the main steps may be:
   i. Preparing a cut blank;
   ii. Deburing or removing any burs from the blank cutting by a small force rimming or so-called “kiss rimming”;
   iii. Preparing recesses (possibly equally spaced) along the outer periphery of the cut blank by using a specially made rimming segment on which, for instance, angled patterns, chevrons, or inclined humps, for instance of a width of between 0.5 to 1.0 mm and of a depth of about 0.2 mm (or 0.1 mm to 0.3 mm), are used to produce the recesses. These so produced recesses are to lock the inserts and the outer ring together upon striking or coining. FIGS. 3a and 3b illustrate the inserts (4,6) having chevron recesses (20) (FIG. 3a) and angled recesses (22) (FIG. 3b). The angles' recesses may be at angles of 30° to 45° from vertical (i.e. the direction of stacking, or perpendicular to the direction of contact between the inserts and the outer ring);
   iv. Annealing to achieve an appropriate hardness;
b) If a plated material is used, the main steps may be:
   i. Preparing a cut blank;
   ii. Deburing and rimming to provide a slightly rimmed edge by a rimming process with a rimming segment of pre-determined rimming profile;
   iii. Softening for a proper hardness by an annealing process;
   iv. Plating in a barrel plating process including cleaning, surface preparation and plating, as well as post annealing when needed;
   v. Preparing recesses (possibly equally spaced) along the outer periphery of the plated blank by using a specially made rimming segment on which for instance, angled patterns, chevrons, or inclined humps, for instance of a width of between 0.5 to 1.0 mm and of a depth of about 0.2 mm (or 0.1 mm to 0.3 mm), are used to produce the recesses. These so produced recesses are to lock the inserts and the outer ring together upon striking or coining.
c) In another embodiment, where a plated material is used, the main steps may be:
   i. Preparing a cut blank;
   ii. Deburing and rimming to provide a slightly rimmed edge by a rimming process with a rimming segment of pre-determined rimming profile;
   iii. Softening for a proper hardness by an annealing process;
   iv Preparing recesses (possibly equally spaced) along the outer periphery of the plated blank by using a specially made rimming segment on which for instance, angled patterns, chevrons, or inclined humps, for instance of a width of between 0.5 to 1.0 mm and of a depth of about 0.2 mm (or 0.1 mm to 0.3 mm), are used to produce the recesses. These so produced recesses are to lock the inserts and the outer ring together upon striking or coining.
   v. Plating in a barrel plating process including cleaning, surface preparation, plating and post annealing.

3. Producing the second insert of a different material as compared to the outer ring and the first insert, either a different metal, or a plated material. This process is similar to Step 2 but with a different material, for instance a metal or a plated material.

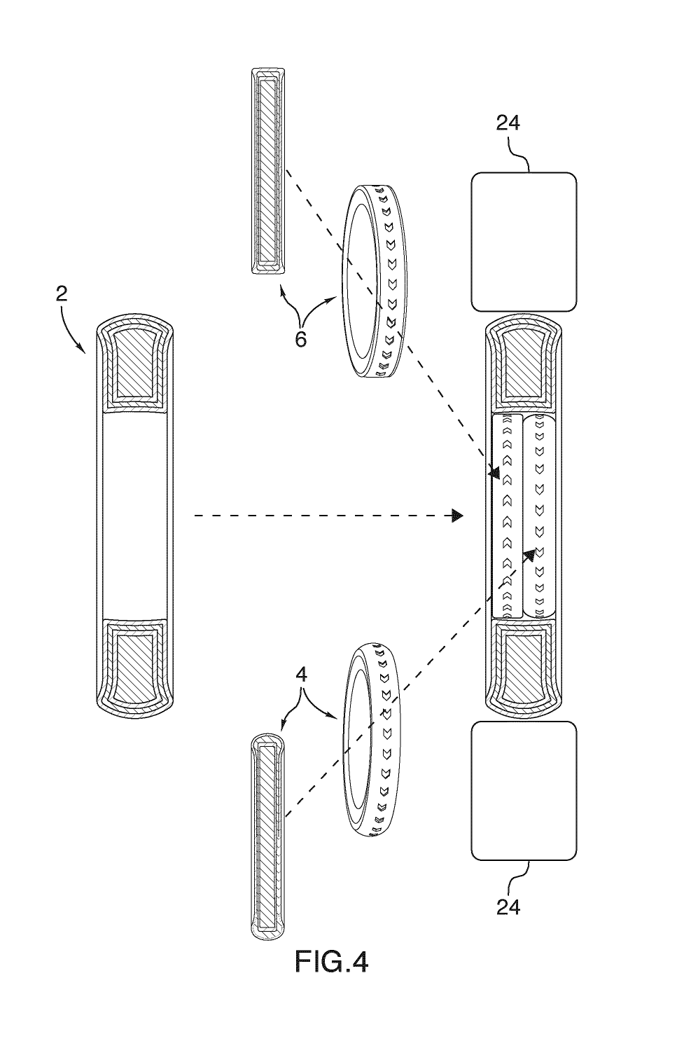

4. As shown in FIG. 4, in a set-up of a coining press with a pair of coining dies and a coining collar (24), three separate blank feeding systems are used to sequentially feed and place the above three major components to the press. First, the ring (2) is placed, and then the first lower insert (4) is placed, followed by the second upper insert (6). These placements may be carried out in an automated system, such as in a Schuler high speed coining press.

5. Stamping or coining during which the three major components are joined together by plastic deformation and the locking mechanism upon the stamping or coining pressure.

The edge profiles of both inner inserts may have a slight chamfering made by a rimming process with a rimming segment of a predetermined rimming profile. The thickness of the ring is slightly thicker than the total thickness of the stacked two inserts, for example 0.1 to 0.2 mm thicker.

The recesses may be, for instance, in the shape of chevrons or angled dents. The recesses may be of a variety of shapes provided that they are not straight lines parallel to the circular axis of the coin since this would not provide adequate locking. The recesses may be equally spaced, or non-equally spaced around the circumference of the inserts. These recesses should be sufficient for the material from the outer ring to flow into so that the inserts and the outer ring become locked together.

By using recesses as described herein, locking can be achieved even when two thin inserts are used, without creating unacceptable dimension changes.

In a situation where the ring material is slightly softer than the insert materials, one may elect to manufacture a composite structure without the use of recesses. In this case, the thickness of the slightly softer outer ring material should be larger than the total thickness of the stacked inserts. Recesses could nonetheless be used in such a case to improve locking.

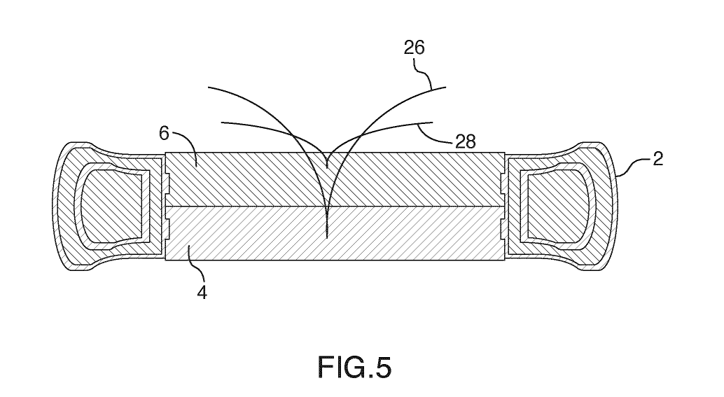

FIG. 5 illustrates one embodiment where the three major components are as follows:

1) The outer ring (2), being a multi-ply plated ring of mild steel as a substrate, a first nickel layer, a middle copper layer, and a top nickel layer.

2) The upper insert (6), a metal 1 or a metal alloy 1, for instance, coinage copper, which is reddish in color.

3) The lower insert (4), a metal 2 or a metal alloy 2, which is a different composition and surface color, for instance aluminum bronze, which is golden yellow in color.

Such a composite coin will have three colors, namely, a white finish of the ring, a red finish on the upper surface, and a golden yellow on the lower surface. These three colors are visible thereby providing a security feature.

With regard to electromagnetic signatures, for instance for vending machine applications, such composite coins will have a distinguished EMS as sensed by high frequency and/or low frequency sensors due to the different materials on the upper and lower sides in the center of the coin. In FIG. 5, the low frequency (26) and high frequency (28) regions are shown. Furthermore, with a consideration of the multi-ply plated outer ring and using a modern vending machine whereby both the center area and the outer area are close to the coin edge, in this particular case, the ring area, are separately detected, this composite coin will provide multiple unique EMS parameters. Although the majority of coin vending machines or coin validators are currently designed and set up to accept the currently available bi-metallic coins, it is feasible technically to come up with a future coin validator or vending machine to evaluate and validate the tri-metallic coins as described herein.

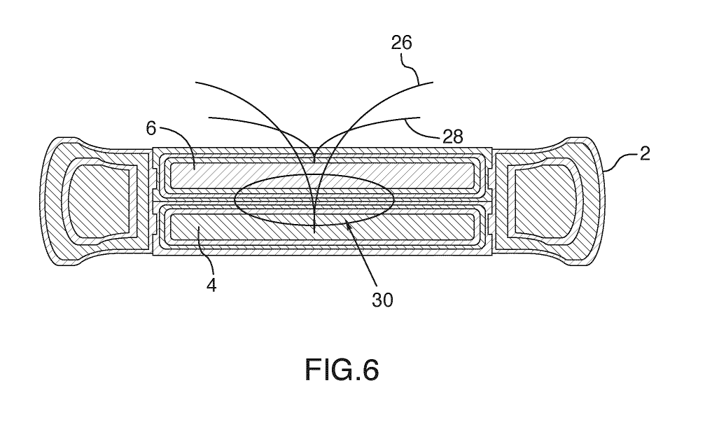

FIG. 6 illustrates one embodiment where the three major components are plated materials, for instance multi-ply materials, as follows:

1) The outer ring (2), being a multi-ply plated ring of mild steel as a substrate, a first nickel layer, a middle copper layer, and a top nickel layer.

2) The upper insert (6), being a multi-ply plated blank of mild steel as a substrate, a first nickel layer, and a top copper layer.

3) The lower insert (4), being a multi-ply plated blank of mild steel as a substrate, a first nickel layer, a middle copper layer, and a top brass or bronze layer.

As shown in FIG. 6, this composite coin has an internal layered structure (30) which is hidden and confined to the center core, in addition to its visual uniqueness of different colors similar to the embodiment of FIG. 5. This layered core may be between 40 to 60 μm, and would be detected by a modern vending sensor, as shown schematically in the shaded circle area. As a result, this composite coin provides a unique and distinguished EMS thus affording protection against counterfeiting. The low frequency (26) and high frequency (28) regions are also shown.

The inserts may also be produced by other means, for example, punched out from a metal strip which is produced by cladding different metals of two layers or multi-ply layers in a cold rolling process.

In another embodiment, the outer ring and the inner inserts are interchangeable in terms of materials, such as an outer ring of brass and bronze alloys or brass and bronze plated or multi-ply plated, and the inner inserts of mono-ply or multi-ply nickel plated and mono-ply or multi-ply- copper plated, or vice versa. In another embodiment, the outer ring material and the inner insert materials can also be interchangeable between plated materials and metals.

The inserts and/or the ring may be circular or non-circular (for instance, multi-sided, in the shape of a scallop, or in the shape of a Rosetta flower). While circular may be the simplest to produce, myriad shapes could be used. In one embodiment, the coining is done by an automatic presses, mechanically or hydraulically. The coining may also be done by manual operation in a press.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

1. A composite structure comprising:
a. an outer ring;
b. two inserts stacked on top of each other and disposed within the outer ring;
c. at least one interlayer disposed between the two inserts for adhering the two inserts to one another; wherein;
the outer ring and each of the two inserts are made of different materials;
the outer ring and the two inserts are made of multi-ply plated materials;
each insert has a surface opposing faces and an outer circumferential surface;
the outer ring and each of the inserts are locked together by a plurality of recesses formed in outer circumferential surfaces of the inserts;
each recess has an opening shape on the outer circumferential surface;
the opening shapes of the recesses are angled with respect to a direction of stacking the inserts; and
the opening shapes of the recesses are angled with respect to a plane co-planar to the opposing faces.

2. The composite structure of claim 1, wherein the recesses are circular or oval, or are in the shape of chevrons or lines angled with respect to a direction of stacking of the inserts.

3. The composite structure of claim 1, wherein the recesses have a depth of 0.1 mm to 0.3 mm.

4. The composite structure of claim 1, wherein the inserts are circular.

5. The composite structure of claim 1, wherein the inserts are non-circular.

6. The composite structure of claim 1, wherein the outer ring is circular.

7. The composite structure of claim 1, wherein the outer ring is non-circular.

8. The composite structure of claim 1, further comprising at least one interlayer disposed between the two inserts for adhering the two inserts to one another.

9. The composite structure of claim 1, wherein the structure is a coin.

10. The composite structure of claim 1, wherein the outer ring and the two inserts are made of metal.

11. The composite structure of any claim 1, wherein the outer ring and the two inserts are plated.

12. The composite structure of claim 1, wherein the outer ring and the two inserts are made of multi-ply plated materials.

13. The composite structure of claim 1, wherein the outer ring is a metal, non-metal, plated metal, plated non-metal, multi-ply plated metal.

14. The composite structure of claim 1, wherein the two inserts are metal, non-metal, plated metal, plated non-metal, multi-ply plated metal.

15. A process for manufacturing a composite structure comprising:
providing an outer ring;
providing a first circular insert and a second circular insert, each of the inserts and the outer ring being of different materials and being made of multi-ply plated material, and each insert having a surface comprising two opposing faces and an outer circumferential surface;
forming a plurality of recesses in outer circumferential surface of each of the inserts, each recess having an opening shape on the outer circumferential surface, wherein the opening shapes of the recesses are angled with respect to a direction of stacking of the inserts, wherein the opening shapes of the recesses are angled with respect to a plane co-planar to the opposing faces;
sequentially feeding into a coining press, the outer ring, the first insert, at least one interlayer for adhering the first and second inserts to one another, and the second insert; and
stamping or coining to join together the outer ring, the first insert, and the second insert.

16. The process of claim 15, further comprising forming the outer ring by:
preparing a cut metal blank;
rimming the blank;
forming an inner hole in the blank to form a ring;
annealing the ring to form an outer metal ring; and
optionally plating the outer metal ring.

17. The process of claim 15, further comprising forming the inserts by:
preparing a cut blank; and
deburring the blank.

18. The process of claim 15, further comprising annealing, cleaning, and plating one or both of the inserts.

19. The process of claim 15, wherein the composite structure is the composite structure according to claim 1.

20. A composite structure made by the process of claim 15.
